(19) United States
(12) Patent Application Publication
(10) Pub. No.: US 2012/0095775 A1
(43) Pub. Date: Apr. 19, 2012

(54) CHARACTERIZING, TRACKING AND OPTIMIZING POPULATION HEALTH BASED ON INTEGRATION OF MULTI-DISCIPLINARY DATABASES

(75) Inventors: PAUL BURTON, ALFORD, FL (US); ROBERT R. FRIEDLANDER, SOUTHBURY, CT (US); RICHARD HENNESSY, AUSTIN, TX (US); JAMES R. KRAEMER, SANTA FE, NM (US); STEPHEN R. ZANDER, WEST LINN, OR (US)

(73) Assignee: INTERNATIONAL BUSINESS MACHINES CORPORATION, ARMONK, NY (US)

(21) Appl. No.: 12/907,346

(22) Filed: Oct. 19, 2010

(51) Int. Cl. G06Q 50/00

(52) U.S. Cl. 705/2

(57) ABSTRACT

A computer implemented method, system and/or computer program product identifies a public health care issue for a specific population based on data from a confederated public health database. A confederated public health database is created from multi-disciplinary databases that include both medical databases and non-medical databases. A health care issue for a specific population is identified based on data from the confederated public health database, in order to create a public health care plan to address that health care issue, which is then transmitted to a public health official.

### BACKGROUND

The present disclosure relates to the field of computers, and specifically to the use of computers in health care. Still more particularly, the present disclosure relates to the use of computers in optimizing health care for specific populations and/or individuals. In one embodiment, the present disclosure operates within the environment of computerized databases.

### BRIEF SUMMARY

A computer implemented method, system and/or computer program product identifies a public health care issue for a specific population based on data from a confederated public health database. A confederated public health database is created from multi-disciplinary databases that include both medical databases and non-medical databases. A health care issue for a specific population is identified based on data from the confederated public health database, in order to create a public health care plan to address that health care issue, which is then transmitted to a public health official.

### BRIEF DESCRIPTION OF THE SEVERAL VIEWS OF THE DRAWINGS

FIG. 1 depicts an exemplary computer in which the present disclosure may be implemented;

FIG. 2 illustrates a relationship among a health care resource computer, a health care provider computer, and multi-disciplinary databases;

FIG. 3 depicts an information hub architecture in accordance with one embodiment of the present disclosure;

FIG. 4 is a high level flow chart of one or more exemplary steps taken by a processor to establish a public health policy using a characterization of population health that is based on an integration of multi-disciplinary databases; and

FIG. 5 is a high level flow chart of one or more exemplary steps taken by a processor to aid in providing appropriate health care to an individual by using a characterization of population health that is based on an integration of multi-disciplinary databases.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

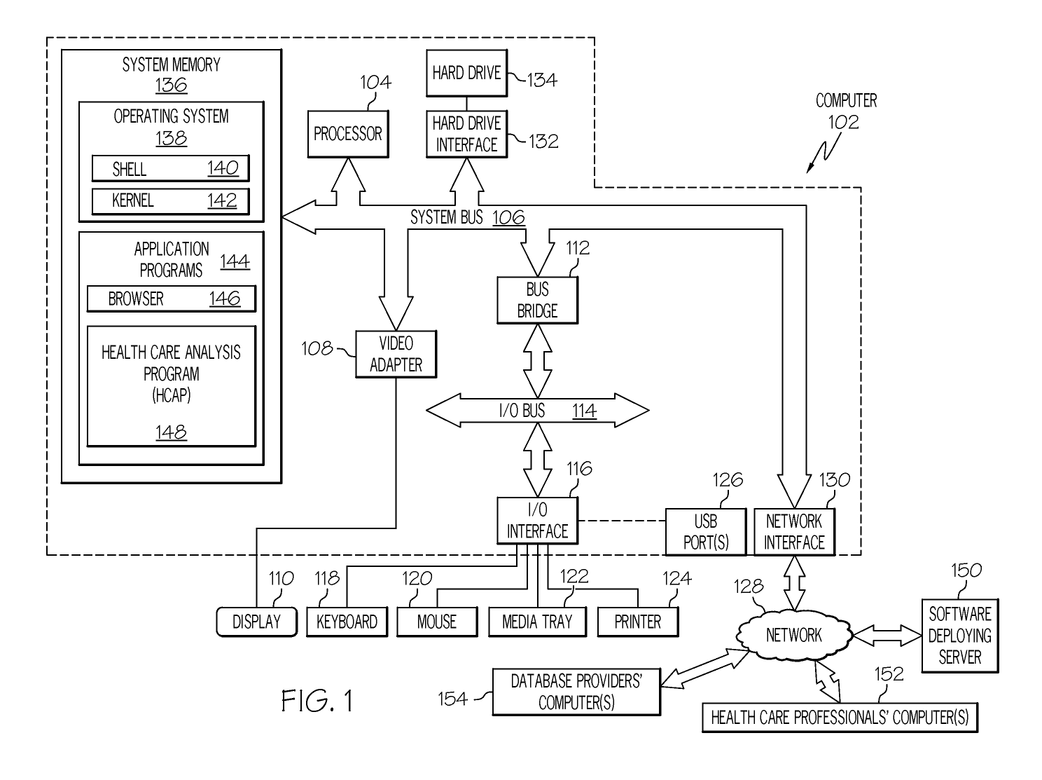

With reference now to the figures, and in particular to FIG. 1, there is depicted a block diagram of an exemplary computer 102, which may be utilized by the present invention. Note that some or all of the exemplary architecture, including both depicted hardware and software, shown for and within computer 102 may be utilized by software deploying server 150, health care professionals' computer(s) 152, and/or database providers' computer(s) 154.

Computer 102 includes a processor 104 that is coupled to a system bus 106. Processor 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other computer systems.

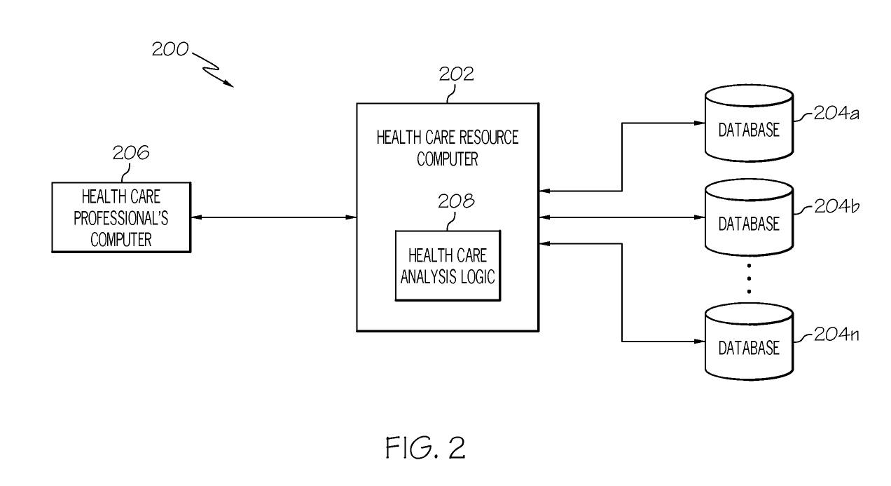

Application programs 144 in computer 102's system memory (as well as software deploying server 150's system memory) also include a health care analysis program (HCAP) 148. HCAP 148 includes code for implementing the processes described below, including those described in FIGS. 2-5. In one embodiment, computer 102 is able to download HCAP 148 from software deploying server 150, including in an on-demand basis, wherein the code in HCAP 148 is not downloaded until needed for execution to define and/or implement the improved enterprise architecture described herein. Note further that, in one embodiment of the present invention, software deploying server 150 performs all of the functions associated with the present invention (including execution of HCAP 148), thus freeing computer 102 from having to use its own internal computing resources to execute HCAP 148.

The hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

Referring now to FIG. 2, a system 200 according to one embodiment of the present disclosure is depicted. System 200 comprises a health care resource computer 202 (analogous to computer 102 shown in FIG. 1), multiple disparate databases 204a-n (where “n” is an integer), which may be provided by the database providers' computer(s) 154 shown in FIG. 1, and a health care professional's computer 206 (analogous to one or more of the health care professionals' computer(s) 152 shown in FIG. 1). Note that the databases 204a-n are disparate databases holding both non-linear and linear data. Non-linear data are defined as data that are not directly related to and/or have no logical connection to any linear (medical) data. For example, database 204a may hold data related to diseases in a certain population, current vaccination statuses, etc. (i.e., medical or “linear” data), while database 204b may hold data related to weather conditions in a region where that certain population lives, census information, normalized datasets, etc. (i.e., non-medical or “non-linear” data), and database 204n may hold data related to epidemiology trends (i.e., medical/linear data) in that region. These databases 204a-n may be from different sources, or they may be from the same or overlapping sources. Within the health care resource computer 202 is a health care analysis logic 208 (analogous to HCAP 148 shown in FIG. 1). Health care analysis logic 208 is able to selectively consolidate data from the disparate databases 204a-n into a confederated database. This confederated database is utilized to provide a health care professional with a health care plan, either for an individual or for a specific population, based on historical data found in the disparate databases 204a-n. That is, the databases 204a-n are not just a collection of past epidemiological trends for a specific population/region, nor are they a collection of symptoms and conditions for a particular individual. Rather, the databases 204a-n include both medical and non-medical data that collectively reveals trends regarding health care issues (for a specific population/region and/or for a particular patient). Thus, these trends are not limited to known medical circumstances. That is, the present disclosure does not present a simple “check the box” public health or medical diagnostic tool based on known diseases/symptoms, but rather presents a process of performing a health care analysis that is based purely on medical and non/medical historical data trends.

Note that some or all of the attribute data from the disparate databases 204a-n are non-linear (i.e., non-medical), in that there is not a direct correlation between a predicted health issue/diagnosis and the data in the some or all of the databases 204a-n. For example, assume that the non-linear attribute data for a country is that it has a democratic political system, has a median family income of $40,000/year, is in the northern hemisphere, and has a per capita rate of cancer that is five times the world average. There is no linear relationship between the political system, median income, and hemisphere location of that country and the fact that its population has a high incidence of cancer. Nonetheless, in accordance with the present disclosure, a correlation (not causation) between these non-linear factors and the cancer rate is deemed significant, such that another country having these same non-linear attributes will be deemed likely to also have an increased incidence of cancer.

In order to determine the likelihood that a second country will also have an increased level of cancer, in one embodiment a Bayesian analysis is used. For example, assume that H represents the hypothesis that the second country will have the same increased cancer rate as a first country, and D represents the event that the second country has the same attributes as the first country. This results in the Bayesian probability formula of:

$$P ( H \vert D ) = \frac{P ( H \vert D ) * P ( H )}{P ( D )}$$

where:
P(H|D) is the probability that a second country will have an increased level of cancer (H) given that (|) the second country has the same attributes (both medical and non-medical) as the first country (D);
P(D|H) is the probability that, if the second country has an increased cancer rate, the second country will have the same attributes as the first country (i.e., even if the hypothesis P(H|D) is true, the two countries may not have the exact same attributes);
P(H) is the probability that the second country will have an increased level of cancer regardless of any other information/facts; and
P(D) is the probability that the second country will have the same non-linear attributes as the first country regardless of any other information/facts.

For example, assume that past studies about several countries shows that any country will have a higher cancer rate relative to the group of countries 50% of the time (P(H)=50%). Assume further that the measured/deduced odds of two countries having the same attributes (non-medical attributes such as its political system, global latitude, median income, etc. as well as medical attributes) are 6 out of 10 (P(D)=60%). Finally, assume that past studies have shown that two countries having the same increased cancer levels will have all of the same shared attributes 80% of the time (P(D|H)=80%). According to these values, the probability that the second country will have an increased level of cancer is therefore 66%:

$$P ( A \vert B ) = \frac{.80 * .50}{.60} = .66$$

However, if past studies have shown that two countries having the same increased cancer levels have all of the same shared attributes 100% of the time (P(D|H)=100%), then the probability that the second country will have an increased level of cancer is now 83%:

$$P ( A \vert B ) = \frac{1.0 * .50}{.60} = .83$$

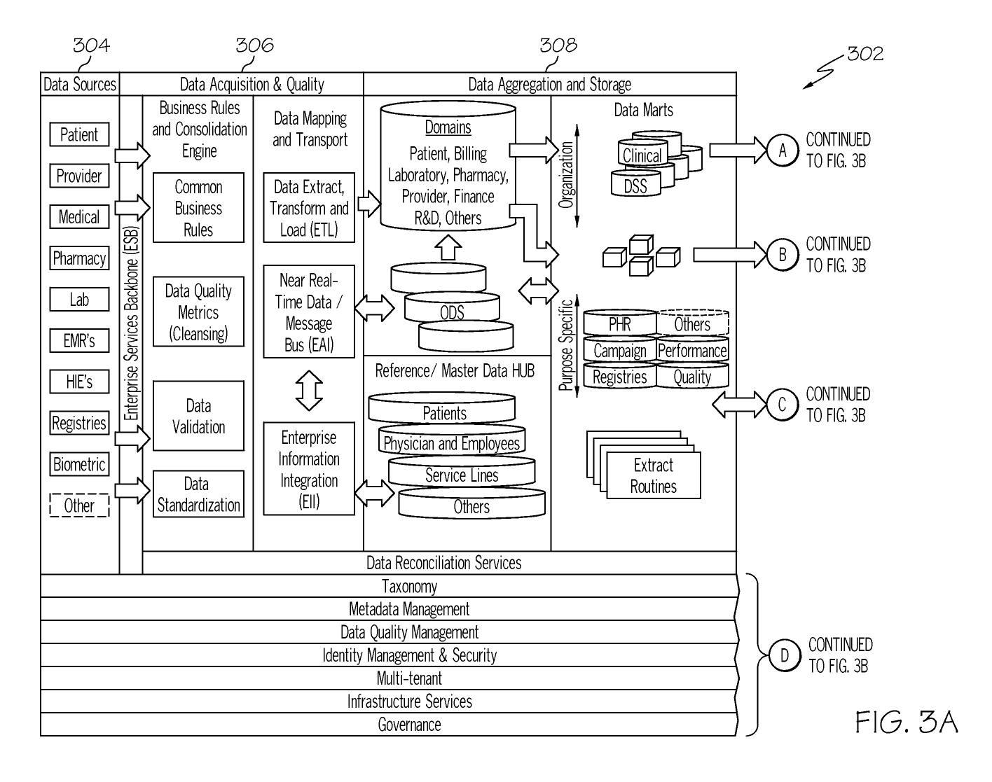

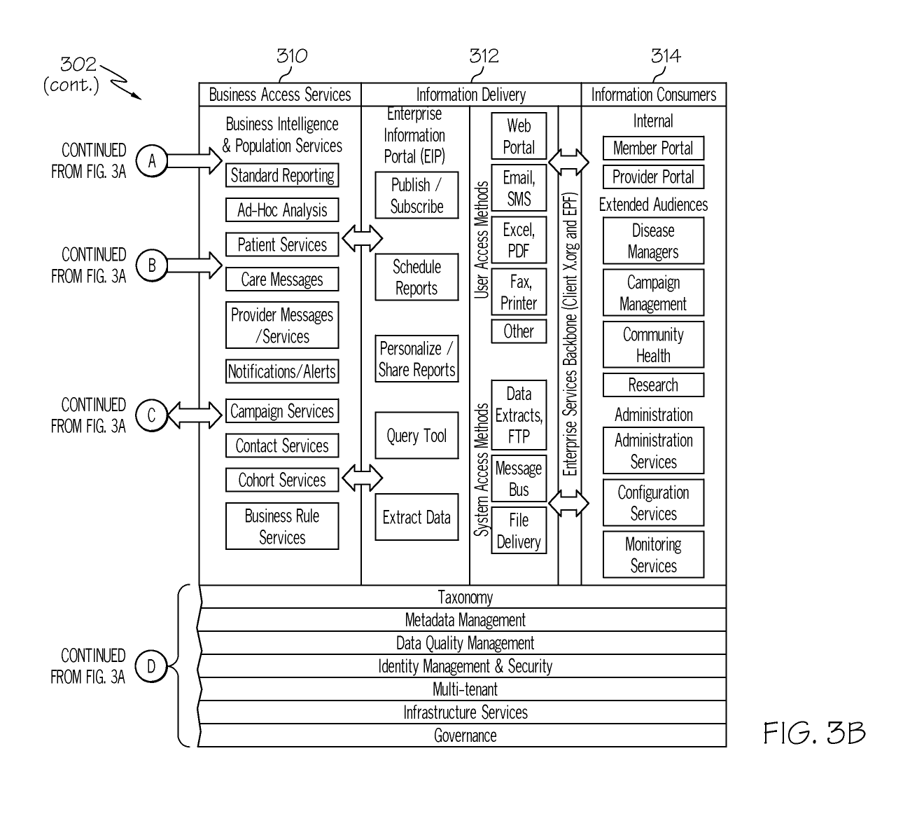

With reference now to FIG. 3, an information hub architecture 302 for use with one embodiment of the present disclosure is presented. The information hub architecture 302 provides governance, infrastructure service, multi-tenant support, identity management and security, data quality management, metadata management, and taxonomy support for the data utilized herein.

Data sources 304 provide data from disparate sources, such as a medical record for a particular patient or group of patients. These records can come from the patient, a pharmacy, a laboratory, electronic medical records (EMR's) sources, health information exchanges (HIE's), etc. Note that these records are all health related, although they come from disparate sources. In addition, data can come from other sources that are not directly health related. That is, data can be based on meteorology, geography, political conditions, demography, etc. for a specific population, which may include a particular patient.

The data is acquired and verified for quality using data acquisition and quality logic 306. Data acquisition and quality logic 306 comprises and utilizes business rules for acquiring data (i.e., in order to conform with security issues, privacy issues, etc.). Data acquisition and quality logic 306 also comprises a consolidation engine, which assembles data into a confederated database using data mapping and transport logic. This confederated database is stored in data aggregation and storage 308 according to different domains, data marts, hubs, etc. That is, each confederated database is specific for a particular problem.

Consider now the particular problem of a country having various linear (medical) and non-linear (non-medical) attributes discussed above. By utilizing appropriate extract routines in the data aggregation and storage 308 to analyze data from the data sources 304, trends can be derived from disparate types of data. For example, a trend may show that persons living in a certain country (that has the various attributes described above) have a historical likelihood of developing a particular disease or condition, even though this particular condition may not be obvious to a health care professional, since there are too many permutations of disease/medication combinations to know what the likely outcome of such combinations may be.

The data from the data aggregation and storage 308 is sent to business access services 310, which include logic (i.e., HCAP 148 shown in FIG. 1) to establish probabilities that certain regions/patients and/or a specific patient will experience a certain medical condition. This information is then sent on to an information delivery system 312 for delivery to information consultants 314. Note further that the information hub architecture 302 also manages taxonomy, metadata management, data quality management, identity management and security, multi-tenant (user) management, infrastructure services, and governance needed to handle this data manipulation and suggestion delivery.

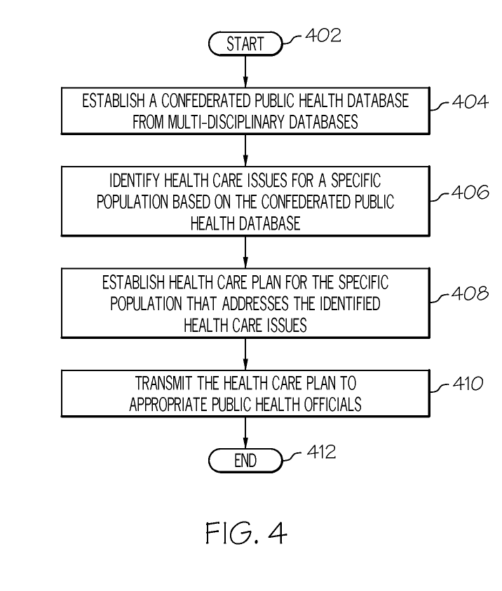

Referring now to FIG. 4, a high level flow chart of one or more exemplary steps taken by a processor to predict health care needs of a specific region/population/country/demographic is presented. After initiator block 402, a confederated public health database is established from multi-disciplinary databases (block 404). This confederated public health database is defined as a combination of linear and non-linear databases, where the linear databases directly describe medical data such as epidemiological issues, and the non-linear databases do not directly describe the medical issues. For example, non-linear databases may contain data for a specific region/population/country/demographic related to climate, local politics, past and present military conflicts, police incident report rates and types, education levels, median income, etc. (which do not directly describe medical issues), as well as linear medical data (i.e., disease patterns, incidence rates, etc. that directly describe medical/epidemiological issues). As described in block 406, health care issues for a specific population are then identified based on the confederated (linear and non-linear) public health database. For example, an analysis (e.g., the Bayesian analysis described above) of linear and non-linear data may show that a particular country is likely to have an outbreak of flu within the next two months (“the identified health care issue”). Based on this prediction, a health care plan is established (block 408). In one embodiment, the same type of methodology used to identify the health care issue is also used to establish the health care plan. For example, assume that a first country previously addressed a flu outbreak after implementing the health care plan of 1) making vaccines optional, 2) increasing the availability of therapeutic medications, and 3) increasing personnel in the public health office. As a result of these actions, the overall population of this country still had a mortality rate of 1 in 25,000 from the flu during the next flu season. However, a second country and a third country took these same steps, but they both had non-linear attributes not held by the first country. The second country and third country experienced a morality rate from the flu of only 1 in 75,000. Thus, if a fourth country holds the same non-linear attributes as the second and third countries, then the health care plan (having steps 1-3) described above is assumed to also result in an acceptable mortality rate for the flu of 1 in 75,000. As such, this plan is transmitted to the fourth country as a viable health care plan (block 410). The process ends at terminator block 412.

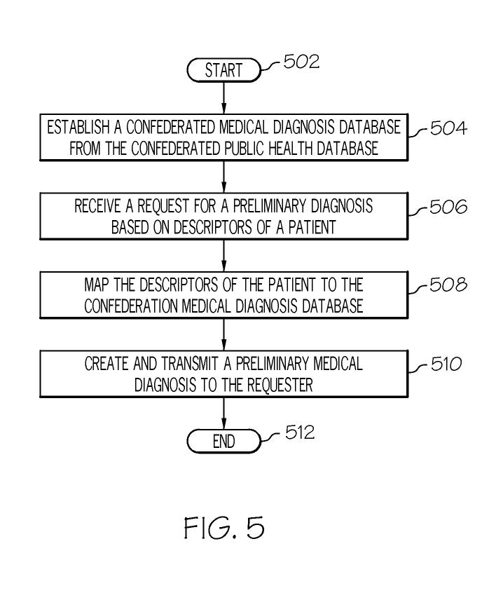

As described by the computer-implemented process shown in FIG. 5, the confederated public health database can be extended to establish a confederated medical diagnosis database (blocks 502-504). That is, the confederated public health database described in FIG. 4 is extended to the individual level. For example, assume that the confederated public health database presents data that predicts a public health issue of a 200% increase in flu cases over the next two months. This information can be utilized in a primary health care provider's office. That is, assume that a health care provider (e.g., using a health care professional's computer 152 shown in FIG. 1) sends a request for a preliminary diagnosis for a specific patient. The request is accompanied by symptom descriptors (fever, runny nose, etc.), patient information (past medical history, current medications, etc.), as well as non-medical descriptors (where the patient lives; annual income of the patient; etc.). These descriptors are mapped to the confederated medical diagnosis database (block 508). That is, assume that a specific patient has the same non-medical attributes as the general population of the first country described above, including an annual income that matches the median annual income for the first country, lives in a similar country (similar climate, political system, military conflict environment, etc.), has an education level that is similar to the median income of the first country, etc. As such, none of these non-linear non-medical attributes would point to a particular diagnosis by themselves. However, when taken in combination with known medical and non-medical attributes of other populations (as represented by the confederated databases), a preliminary medical diagnosis is created for transmission to the requesting health care professional (block 510). The health care professional can then conduct additional tests/examinations to confirm or rule out the preliminary medical diagnosis. The process ends at terminator block 512.

Note that the processes described herein may be utilized at any population level, including local (city, county, state), national, worldwide, etc. Furthermore, the processes described herein may be focused on a particular demographic, such as populations within a certain income range, having a certain educational level, etc. In addition, the public health care plan derived by the processes described herein may be hierarchical. For example, if the processes described herein result in the creation of a public health care plan at a national level, that national public health care plan may be used to aid a local public health care plan if the data from respective confederated databases (for the national and local population) are similar to a predetermined degree.

Note also that while the present disclosure has been presented in the context of health care issues, the principals and processes described herein are also applicable in use to other issues, including but not limited to, distribution of energy resources, food, money, etc., based on a confederated database made up of multi-disciplinary databases showing a correlation between certain attributes of data in the confederated database and a plan for allocating such resources.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the invention of the present application in detail and by reference to illustrative embodiments thereof, it will be apparent that modifications and variations are possible without departing from the scope of the invention defined in the appended claims.

What is claimed is:

1. A computer implemented method of identifying a public health care issue for a specific population based on data from a confederated public health database, the computer implemented method comprising:
a processor creating a confederated public health database from multi-disciplinary databases, wherein the multi-disciplinary databases comprise both a medical database and a non-medical database, wherein the medical database directly describes a public health issue, and wherein the non-medical database does not describe the public health issue;
the processor identifying a health care issue for a specific population based on data from the confederated public health database;
the processor creating a public health care plan to address the health care issue; and
the processor transmitting the public health care plan to a public health official.

2. The computer implemented method of claim 1, further comprising:
the processor identifying the health care issue by comparing other populations to the specific population, wherein the other populations share same medical and non-medical attributes.

3. The computer implemented method of claim 1, further comprising:
the processor establishing a relationship between the other populations and the specific population through use of a Bayesian algorithm that establishes a correlation between shared attributes and shared health care issues for the other populations and the specific population.

4. The computer implemented method of claim 1, further comprising:
the processor establishing a confederated medical diagnosis database from the confederated public health database;
the processor receiving a request for a preliminary diagnosis for an individual patient, wherein the request comprises medical symptoms of the individual patient and non-medical information about the individual patient;
the processor mapping the medical symptoms of the individual patient and the non-medical information about the individual patient to the confederated medical diagnosis database; and
the processor creating a preliminary medical diagnosis for the individual patient based on the confederated medical diagnosis database.

5. A computer program product for identifying a public health care issue for a specific population based on data from a confederated public health database, the computer program product comprising:
a computer readable storage media;
first program instructions to create a confederated public health database from multi-disciplinary databases, wherein the multi-disciplinary databases comprise both a medical database and a non-medical database, wherein the medical database directly describes a public health issue, and wherein the non-medical database does not directly describe the public health issue;
second program instructions to identify a health care issue for a specific population based on data from the confederated public health database;
third program instructions to create a public health care plan to address the health care issue; and
fourth program instructions to transmit the public health care plan to a public health official; and wherein
the first, second, third, and fourth program instructions are stored on the computer readable storage media.

6. The computer program product of claim 5, further comprising:
fifth program instructions to identify the health care issue by comparing other populations to the specific population, wherein the other populations share same medical and non-medical attributes; and wherein
the fifth program instructions are stored on the computer readable storage media.

7. The computer program product of claim 5, further comprising:
fifth program instructions to establish a relationship between the other populations and the specific population through use of a Bayesian algorithm that establishes a correlation between shared attributes and shared health care issues for the other populations and the specific population; and wherein
the fifth program instructions are stored on the computer readable storage media.

8. The computer program product of claim 5, further comprising:
fifth program instructions to establish a confederated medical diagnosis database from the confederated public health database;
sixth program instructions to receive a request for a preliminary diagnosis for an individual patient, wherein the request comprises medical symptoms of the individual patient and non-medical information about the individual patient;
seventh program instructions to map the medical symptoms of the individual patient and the non-medical information about the individual patient to the confederated medical diagnosis database; and
eighth program instructions to create a preliminary medical diagnosis for the individual patient based on the confederated medical diagnosis database; and wherein
the fifth, sixth, seventh, and eighth program instructions are stored on the computer readable storage media.

9. A computer system comprising:
a central processing unit (CPU), a computer readable memory, and a computer readable storage media;
first program instructions to create a confederated public health database from multi-disciplinary databases, wherein the multi-disciplinary databases comprise both a medical database and a non-medical database, wherein the medical database directly describes a public health issue, and wherein the non-medical database does not directly describe the public health issue;
second program instructions to identify a health care issue for a specific population based on data from the confederated public health database;
third program instructions to create a public health care plan to address the health care issue; and
fourth program instructions to transmit the public health care plan to a public health official; and wherein
the first, second, third, and fourth program instructions are stored on the computer readable storage media for execution by the CPU via the computer readable memory.

10. The computer system of claim 9, further comprising:
fifth program instructions to identify the health care issue by comparing other populations to the specific population, wherein the other populations share same medical and non-medical attributes; and wherein
the fifth program instructions are stored on the computer readable storage media for execution by the CPU via the computer readable memory.

11. The computer system of claim 9, further comprising:
fifth program instructions to establish a relationship between the other populations and the specific population through use of a Bayesian algorithm that establishes a correlation between shared attributes and shared health care issues for the other populations and the specific population; and wherein
the fifth program instructions are stored on the computer readable storage media for execution by the CPU via the computer readable memory.

12. The computer system of claim 9, further comprising:
fifth program instructions to establish a confederated medical diagnosis database from the confederated public health database;
sixth program instructions to receive a request for a preliminary diagnosis for an individual patient, wherein the request comprises medical symptoms of the individual patient and non-medical information about the individual patient;
seventh program instructions to map the medical symptoms of the individual patient and the non-medical information about the individual patient to the confederated medical diagnosis database; and
eighth program instructions to create a preliminary medical diagnosis for the individual patient based on the confederated medical diagnosis database; and wherein
the fifth, sixth, seventh, and eighth program instructions are stored on the computer readable storage media; and wherein
the fifth, sixth, seventh, and eighth program instructions are stored on the computer readable storage media for execution by the CPU via the computer readable memory.
